(19) United States
(12) Patent Application Publication
(10) Pub. No.: US 2009/0019812 A1
(43) Pub. Date: Jan. 22, 2009

(54) Anchoring Apparatus and Method

(76) Inventors: Steve Getz, Michigan City, IN (US); William Bast, Highland Park, IL (US); Scott Nacheman, Glenview, IL (US); Rachel Michelin, Chicago, IL (US); Dziugas Reneckis, Chicago, IL (US)

Correspondence Address: FITCH EVEN TABIN AND FLANNERY, 120 SOUTH LA SALLE STREET, SUITE 1600, CHICAGO, IL, 60603-3406, US

(21) Appl. No.: 12/173,954

(22) Filed: Jul. 16, 2008

Related U.S. Application Data
(60) Provisional application No. 60/950,481, filed on Jul. 18, 2007.

(51) Int. Cl. E04B 1/38; B23P 11/00

(52) U.S. Cl. 52/704; 29/525.01

(57) ABSTRACT

An anchoring apparatus that is suitable for use in anchoring a first member (such as but not limited to a façade material) (22) to a second member (such as but not limited to a building exterior) (21). This anchoring apparatus can comprise, for example, a base member (51) that is configured and arranged to move selectively along an anchor limb (30) (which might be, for example, secured to the second member) and a plurality of fingers (52) that are attached to the base member and which are selectively movable, only once, from a non-deployed state to a deployed state.

### CROSS REFERENCE TO RELATED APPLICATIONS

This application claims the benefit of the filing date of U.S. Provisional Application 60/950,481 which is hereby incorporated in its entirety herein.

### TECHNICAL FIELD

This invention relates generally to techniques for securing two members together, and more particularly to anchoring a façade material to an exterior surface of a building.

### BACKGROUND

Various mechanisms are known in the art for securing one member to another, including nails, screws, bolts, and the like. These approaches serve well for a wide variety of securement purposes. There are, however, some application settings, restoration application settings, for example, where such mechanisms will not necessarily prove adequate.

One such application setting comprises the securement of façade materials to the exterior of a building. One illustrative example in this regard is the use of marble panels as a façade for a tall multi-story building having a concrete exterior. In such a case, and in varying degrees relating to the materials involved, the resistance of significant wind loads (both inward and outward of the concrete exterior) on the stone panel, the relative size of the façade materials, as well as spacing requirements to be maintained between the building exterior and the façade materials, such ordinary affixment means are often inadequate to the task.

Various alternative approaches have been suggested to meet the needs of such an application setting. Though usually (although not always) sufficiently strong enough to retain the façade materials in a desired position and orientation with respect to the building's exterior, such approaches have also tended to be relatively costly, time consuming and/or complicated to install, and error prone. In many cases, such alternative solutions have also proven to present difficulties when later seeking, for whatever reason, to reverse the installation process.

The present invention may be used to fulfill these needs, as well as other needs and benefits, as will be apparent from the following description of embodiments of the present invention. Additionally, the design of the apparatus provides for a non-destructive method to monitor performance of the anchoring system over a period of time and provide for a quantitative quality control procedure and method to determine a proper installation.

### BRIEF DESCRIPTION OF THE DRAWINGS

The above needs are at least partially met through provision of the anchoring apparatus and method described in the following detailed description, particularly when studied in conjunction with the drawings, wherein:

FIG. 1 comprises a flow diagram as configured in accordance with various embodiments of the invention;

FIG. 2 comprises a side elevational sectioned view as configured in accordance with various embodiments of the invention;

FIG. 3 comprises a side elevational view as configured in accordance with various embodiments of the invention;

FIG. 4 comprises a side elevational view as configured in accordance with various embodiments of the invention;

FIG. 5 comprises a side elevational view as configured in accordance with various embodiments of the invention;

FIG. 6 comprises a bottom plan view as configured in accordance with various embodiments of the invention;

FIG. 7 comprises a perspective view as configured in accordance with various embodiments of the invention;

FIG. 8 comprises a side elevational view as configured in accordance with various embodiments of the invention;

FIG. 9 comprises a perspective view as configured in accordance with various embodiments of the invention;

FIG. 10 comprises a bottom plan view as configured in accordance with various embodiments of the invention;

FIG. 11 comprises a side elevational view as configured in accordance with various embodiments of the invention;

FIG. 12 comprises a side elevational view as configured in accordance with various embodiments of the invention;

FIG. 13 comprises a side elevational view as configured in accordance with various embodiments of the invention;

FIG. 14 comprises a side elevational view as configured in accordance with various embodiments of the invention;

FIG. 15 comprises a side elevational view as configured in accordance with various embodiments of the invention; and

FIG. 16 comprises a side elevational sectioned view as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, these various embodiments make use of an anchoring apparatus that is suitable for use in anchoring or stabilizing one member (such as but not limited to a façade material) to another member (such as but not limited to a building exterior). This anchoring apparatus can comprise, for example, a base member that is configured and arranged to move selectively along an anchor limb (which might be, for example, secured to the latter member) and a plurality of fingers that are attached to the base member and which are selectively movable, only once, from a non-deployed state to a deployed state.

By one approach, this anchoring apparatus can comprise an integral member. If desired, this anchoring apparatus can have a substantially cylindrical shape (when the fingers are in the non-deployed state) and can further have an axially-located aperture formed therethrough to accommodate the anchor limb. By one approach, this apparatus can be substantially frustoconical in shape when the fingers are in the deployed state. These teachings will further accommodate coupling the fingers to the base member at a hinge (such as, but not limited to, an annular ring formed in the apparatus) to thereby facilitate movement of the fingers from the non-deployed state to the deployed state.

These teachings will further accommodate provision of a wedge member that is configured and arranged to be selectively wedged between the plurality of fingers to thereby selectively move the fingers from the non-deployed state to the deployed state. In such a case, the aforementioned base member/fingers can be positioned along the anchor limb between a first one of the members and the second member (via, for example, a corresponding hole in the outer member). The wedge member can then be selectively moved between the fingers to move the fingers from the non-deployed state to a deployed state. If desired, a cap can then engage the anchor limb to thereby captivate the outer member between the cap and the plurality of fingers of the anchoring apparatus to thereby retain the outer member in place with respect to the inner member.

Those skilled in the art will recognize and appreciate that these teachings offer a simple, rapidly and easily installed attachment mechanism for securing a first member to a second member. It will further be appreciated that these teachings are highly scalable and will accommodate a wide range of application settings including, for example, the securement of heavy façade materials to the exterior of a building.

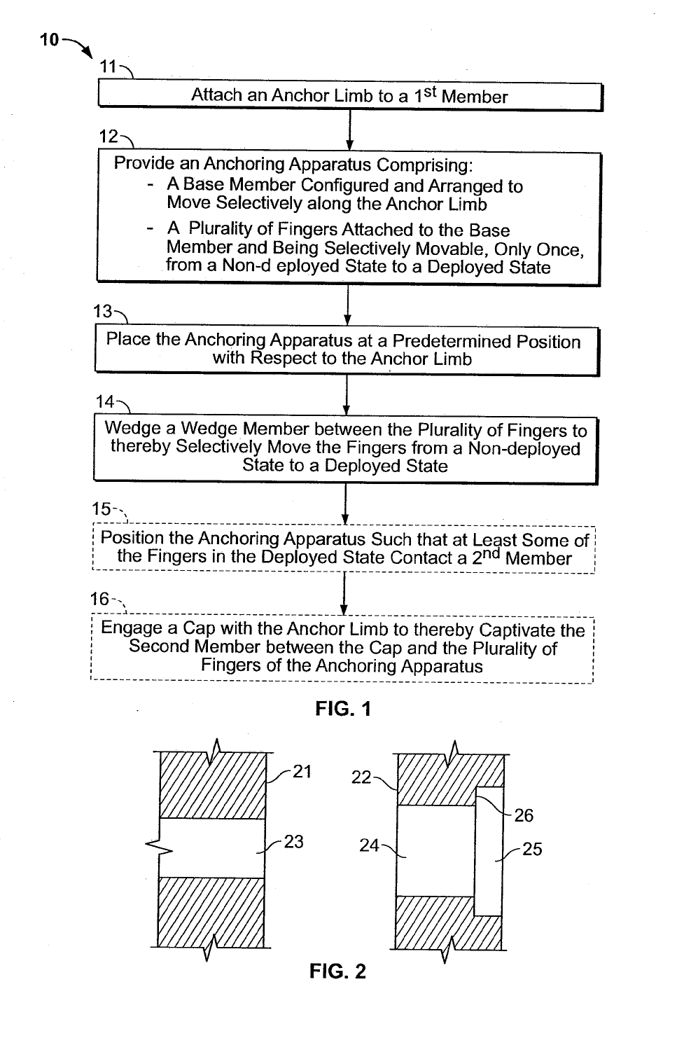

These and other benefits may become clearer upon making a thorough review and study of the following detailed description. Referring now to the drawings, and in particular to FIG. 1, an illustrative process 10 suitable to represent at least certain of these teachings will be described.

This process 10 can be used in conjunction with, for example, a first member such as an exterior wall of a building and a second member such as a façade element. Those skilled in the art will appreciate and recognize that the use of such an example is intended to serve only for the purposes of illustration and is not intended to serve as an exhaustive or otherwise limiting example in this regard.

With momentary reference to FIG. 2, the first member 21 can have an opening 23 formed therein (using, for example, a drill bit having an appropriately-sized diameter) in order to receive an anchor limb as described below. The second member 22, in turn, can have an opening 24 disposed therethrough (again using an appropriately-sized drill bit, for example). In a typical embodiment, this opening 24 through the second member 22 may have a larger or equal diameter than the hole 23 formed in the first member 21. As will be shown below, these differently-sized holes 23 and 24 serve to accommodate differently-sized components. These teachings will also accommodate another hole 25 that is formed coaxially with the hole 24 in the second member 22. This hole 25 can have a larger diameter in order to form an annularly-shaped shelf 26. As will also be shown below, this shelf 26 can serve to interface with a cap described herein.

Those skilled in the art will understand that this first and second member 21 and 22 can be comprised of almost any building material having sufficient structural integrity to suit the needs and requirements of a given application setting. For the purposes of illustration and not by way of limitation, it will be assumed here that the first member 21 is comprised of concrete while the second member 22 is comprised of marble.

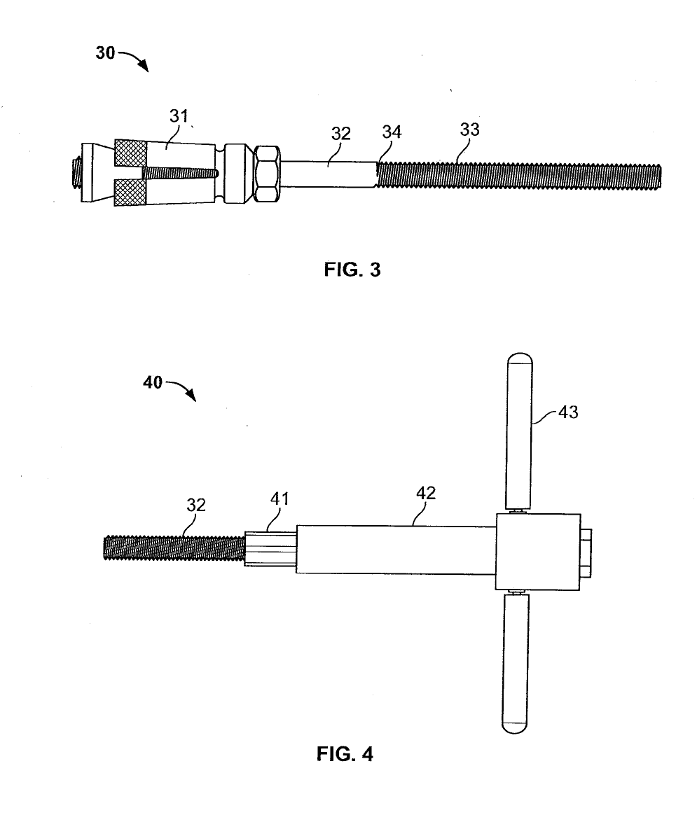

By one approach, this process 10 provides for attaching 11 an anchor limb to the aforementioned first member. Such an anchor limb can assume a variety of forms. One illustrative example appears in FIG. 3. In this illustrative example, the anchor limb 30 comprises a threaded shaft 32 that connects at one end to a standard concrete anchor 31 as is known in the art. By placing this concrete anchor 31 into the aforementioned hole (23 in FIG. 2), the anchor 31 can then be caused to expand and thereby cause the anchor to become securely lodged in the first member. With many such components, the concrete anchor 31 expands in response to rotation of the aforementioned shaft 32. Referring momentarily to FIG. 4, such rotation can be readily accomplished by use of a simple hand tool 42 having a first end 41 that engages the end of the shaft and an opposing end having hand-graspable members 43 that can be readily manipulated by an installer. As such concrete anchors are well known in the art, further elaboration in this regard will not be provided here for the sake of brevity.

By one approach, the shaft 32 can be threaded along its entire length. In this example, however, the shaft 32 is only threaded 32 for a portion of its length. This results in a natural stop 34 beyond which a component that engages these threads cannot pass. In this particular example this stop 34 serves a useful purpose and hence has been intentionally placed at a particular location along the shaft 32. This anchor limb 30 can be formed of any useful material with an appropriate metal, such as steel or some corresponding alloy, being suitable for many typical applications.

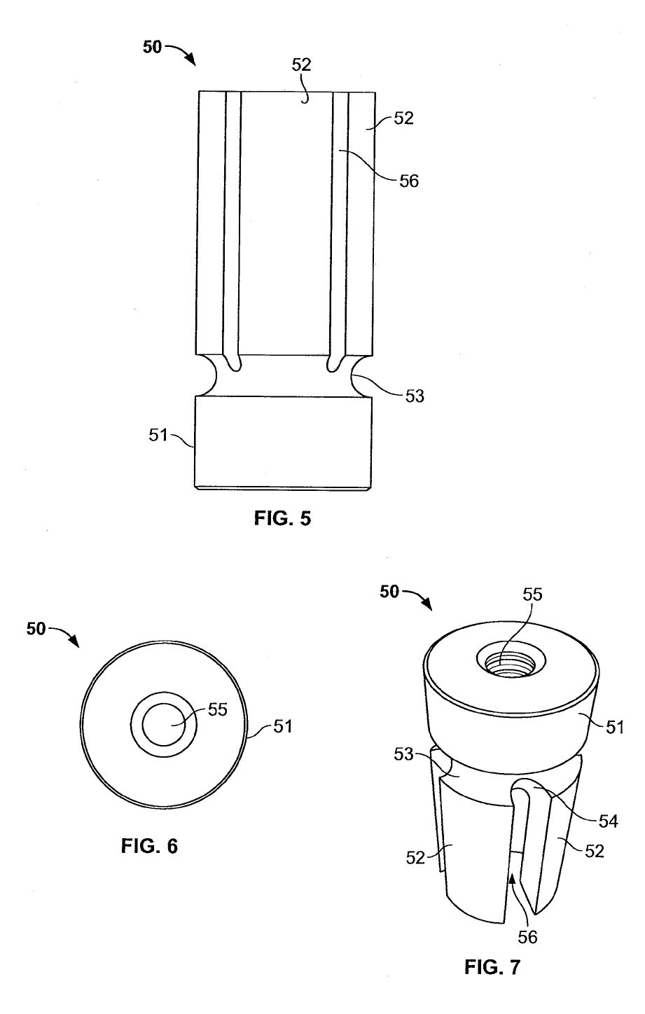

Referring again to FIG. 1 and also to FIGS. 5, 6, and 7, this process 10 also provides for an anchoring apparatus 50 that includes, at least in part, a base member 51 and a plurality of fingers 52. These elements can be formed of an integral, one-piece body if desired and of any suitable material including, but not limited to, a material selected from the group comprising metals, plastics, polymers, super polymers, engineered plastics, composite materials, and combinations thereof, to note but a few examples in this regard. In this particular example, and for the purposes of illustration only, it will be presumed that this anchoring apparatus 50 is comprised of brass. Depending upon the material selected, this component can comprise a machined part and/or a molded component as will be well understood by those skilled in the art.

By one approach, this base member 51 is configured and arranged to move selectively along the anchor limb 30. In this example, the base member 51 includes an internally-threaded, axially located aperture 55 formed therethrough to accommodate the threaded portion 33 of the anchor limb 30.

The plurality of fingers 52, in turn, are attached to the base member 51 at a first end thereof. The second, unattached ends of the fingers 52 extend away from the base 51 and are separated from one another by a slot 56. By one approach, these fingers 52 are coupled to the base member 51 via an annular ring 53 that is formed in the aforementioned integral body. This annular ring 53 serves as a hinge, with this hinge being configured and arranged to facilitate movement of these fingers 52 from a non-deployed state to a deployed state (to be described below). If desired, to further aid in relieving stress on the plurality of fingers 52 during movement of the fingers 52 to a deployed state the aforementioned slots 56 can each further comprise a curved inner portion 54 in communication with this annular ring 53.

The number of fingers 52 can vary with the requirements and/or opportunities as tend to characterize a given application setting. As illustrated, there are four such fingers 52 formed substantially equidistant from one another about the circumference of the base member 51.

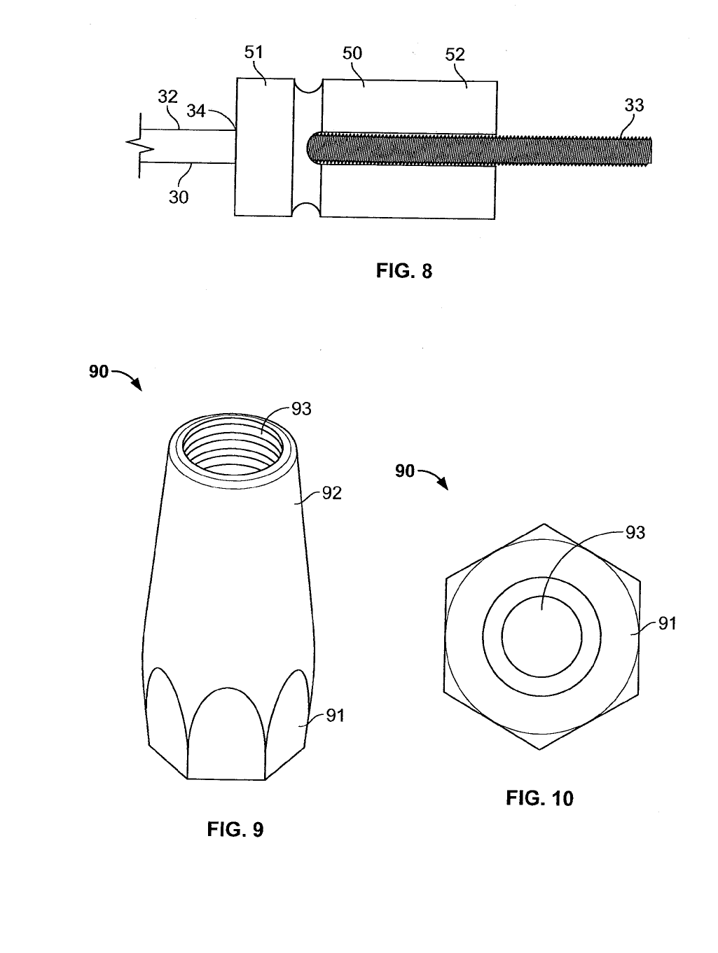

Referring now to FIGS. 1 and 8, this process 10 then provides for placing 13 the anchoring apparatus 50 at a predetermined position with respect to the anchor limb 30. As suggested above, this can comprise inserting the threaded portion 33 of the anchor limb 30 into the base member's threaded hole 55 and rotating the anchoring member 50 about the anchor limb 30 to thereby move the former along the latter. The aforementioned predetermined position can comprise a location where the anchoring apparatus 50 is fully disposed within the space between the first member and the second member that are to be coupled to one another.

Such a position will facilitate deploying the fingers 52 as described below. By one approach, this predetermined position can correspond to placement of the aforementioned stop 34. So configured, the anchoring apparatus 50 will simply stop rotating upon encountering the stop 34. This, in turn, makes correct initial placement of the anchoring apparatus 50 quite simple, intuitive, and essentially automatic.

Referring now to FIGS. 9 and 10, a next step in the process 10 will make use of a wedge member 90. This wedge member 90 can comprise a component that is non-integral with the aforementioned integral body as comprises at least a portion of the anchoring apparatus 50. As with the latter, the wedge member 90 can be formed of any suitable material. In this illustrative example, the wedge member 90 is formed of brass.

This wedge member 90 has a base portion 91 that includes a hexagon-shaped outer portion to facilitate being gripped and manipulated by a corresponding tool. The remaining portion of the wedge member 90 comprises a substantially cone-shaped wedge 92. A threaded aperture 93 extends axially through the wedge member 90 in order to facilitate placement and movement of the wedge member 90 on the anchor limb 30.

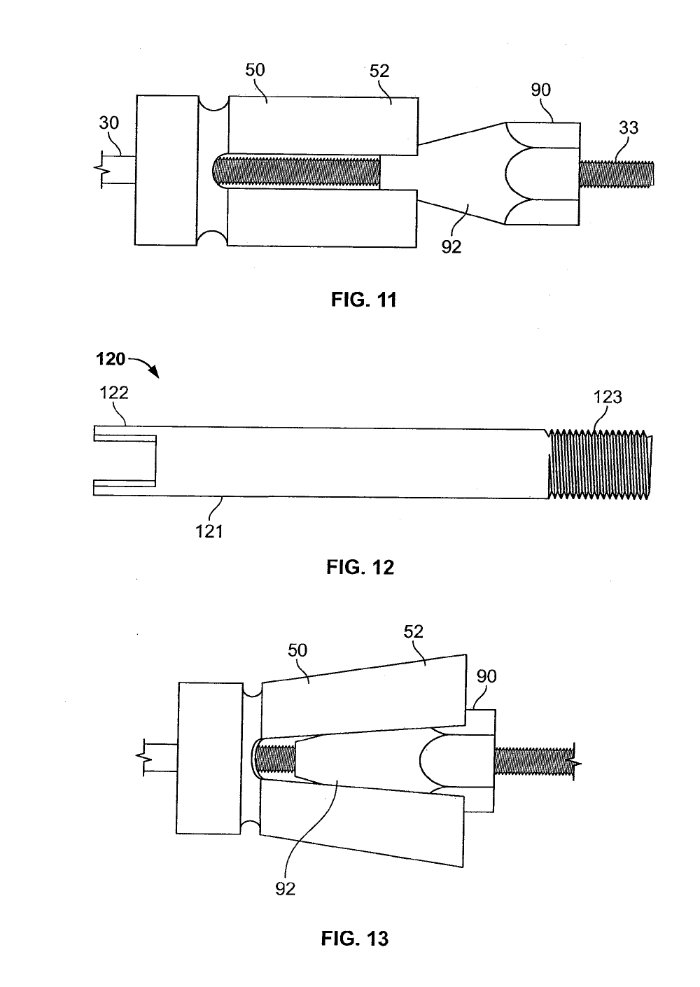

Referring now to FIGS. 1 and 11, this process 10 provides for wedging 14 this wedge member 90 between the fingers 52 of the anchoring apparatus 50. The wedge member 90 is moved into initial contact with the fingers 52 by rotating the wedge member 90 about the threaded portion 33 of the anchor limb 30. The wedge member 90 may be placed a short distance inwardly of the fingers 52 by hand if desired. At some point, however, the wedge member 90 contacts the inner surfaces of the fingers 52 and resistance against such rotation will increase greatly.

In order to continue wedging the wedge member 90 between these fingers 52, a corresponding tool (a socket wrench, for example) can be used. The structure and use of a socket wrench being well known to those in the art, further elaboration in this regard need not be provided here.

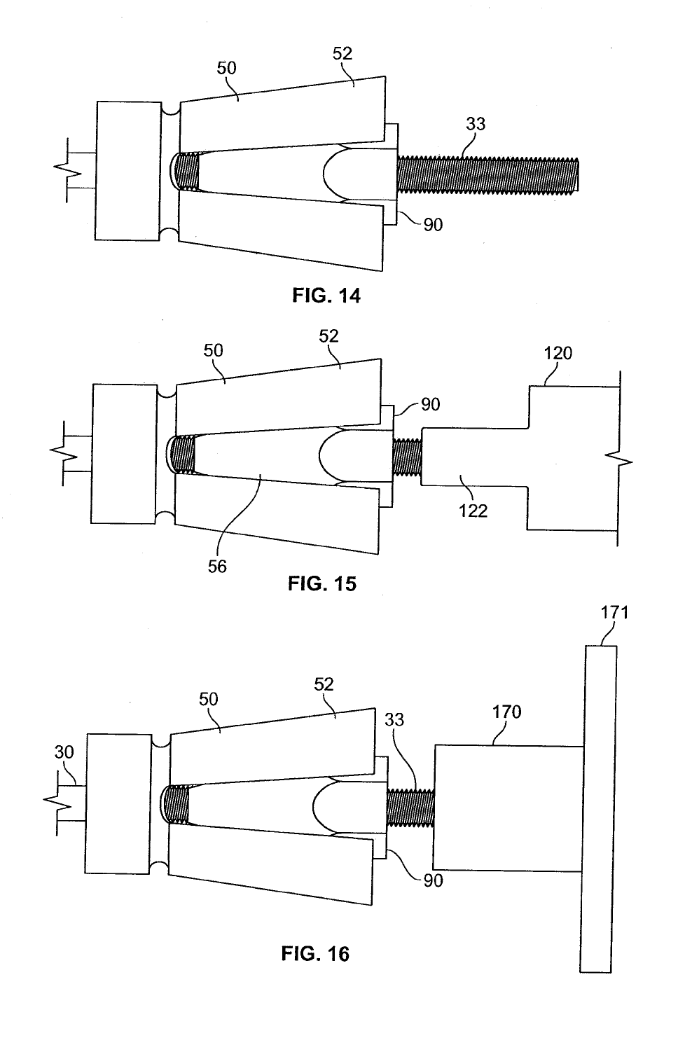

As shown in FIG. 13, such rotation of the wedge member 90 can continue until the wedge member 90 has been moved sufficiently inwardly of the fingers 52 in order to cause the latter to move from a non-deployed state to the deployed state as shown. Once the wedge member 90 has been moved sufficiently inwardly of fingers 52 to cause the latter to move to the deployed state, the tool will no longer be capable of communicating with the wedge member 90 to continue to cause the rotation of the wedge member 90. As with the initial placement of the anchoring apparatus 50, this communication between the wedge member 90 and the tool makes correct placement of the wedge member and, consequently, correct deployment of the fingers 52, quite simple, intuitive, and essentially automatic. If desired, the wedge member 90 could be left in place. Or, if desired and as shown in FIG. 14, the wedge member 90 can be removed by reversing the direction of rotation.

Given the rigidity of the materials used to form the anchoring apparatus 50, once deployed, the fingers 52 will remain in the deployed state even upon removing the wedge member 90. Accordingly, for all practical purposes, the fingers 52 are seen to be selectively movable, only once, from a non-deployed position to a deployed position. This characterizing will be recognized and understood by those skilled in the art as referring to the ordinary use and deployment of such an apparatus. Obviously, these fingers 52 can be forced back to their original positions through application of some external (and considerable) force using some tool of choice; such an action, however, comprises a non-ordinary and unintended event and is not to be considered as comprising a part of the expression, “being selectively movable, only once, from a non-deployed state to a deployed state.”

This process 10 will then accommodate positioning 15 the anchoring apparatus 50 such that at least some of the fingers 52 in the deployed state will contact the second member. This can be accomplished, in the present illustrative example, by rotating the anchoring apparatus 50 in an opposite direction to move the anchoring apparatus 50 away from the first member 21 and back towards the second member 22. If desired, and referring now to FIG. 15, a corresponding tool 120 as shown in FIG. 12 can assist in this regard. This tool 120 comprises a hollow shaft having a first end 121 having parallel blades 122 extending therefrom and a second end 123 having threads formed thereabout to accommodate, for example, affixment to a drive tool of choice. Referring now to FIG. 15, the parallel blades 122 are shaped, spaced, and sized to fit within the slots 56 between the deployed fingers 52. The tool 120 can then be rotated accordingly to effect the described movement of the anchoring apparatus 50.

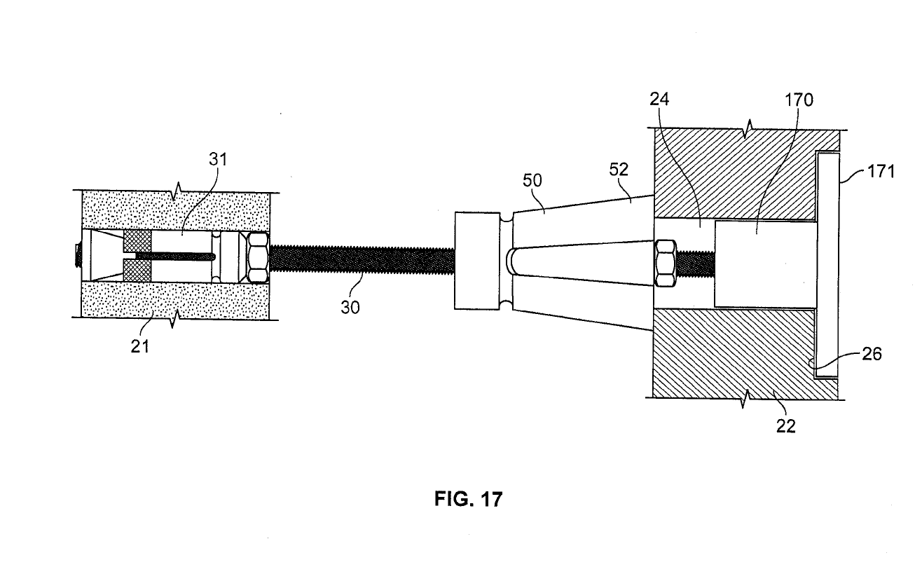

Referring now to FIGS. 1, 16, and 17, a cap 170 can then engage 16 the anchor limb 30 to thereby captivate the second member between the cap 170 and the plurality of fingers 52 of the anchoring apparatus 50. This cap 170 can comprise a cylinder comprised of some sturdy material (such as, in this illustrative example, stainless steel) having an external diameter that closely matches the aforementioned hole 24 in the second member 22 and a threaded axial opening formed part way therein to threadably engage the anchoring limb 30. An opposing end of the cap 170 can have a tool-interface (such as, but not limited to, a hex tool interface) formed therein to permit the cap 170 to be rotated and tightly secured in place as described. To further assist in this regard, the cap 170 can include an enlarged-diameter end flange 171 that can interface with the aforementioned shelf 26 as was also formed in the second member 22.

So configured, the second member 22 can be quickly, efficiently, and securely attached to the first member 21 using only very simple tools and a small assortment of anchor components. At least one of these components, the wedge member 90, can be reused from one installation to the next if desired. It will also be understood and appreciated that the cap 170 can be selectively removed if desired, and the anchoring apparatus 50 again rotated to move the fingers 52 away from the second member 22 to thereby readily permit subsequent removal of the second member 22 should that become desirable in the future for whatever reason.

Depending upon the dimensions, material weights, and other factors of interest in a given application setting, one or more of the above-described assemblies can be employed for a single second member 22 (for example, for a single façade element). As these assemblies work independently of one another, such a design selection can be made without any particular concern for interoperability requirements or the like.

Those skilled in the art will recognize and understand that these teachings will be particularly applicable in restoration applications, and more particularly, to applications where, as a result of the materials involved, wind loads, the relative size of the façade materials, as well as spacing requirements to be maintained between the building exterior and the façade materials, it is necessary to re-anchor an existing façade material to an exterior surface of a building without removing or replacing the existing façade.

Those skilled in the art will also recognize and understand that these teachings are highly scalable. Accordingly, the various described components can be made using any of a wide variety of dimensions (both absolute and relative to one another) to thereby accommodate any of a very wide variety of application settings and requirements.

Those skilled in the art will also recognize that a wide variety of modifications, alterations, and combinations can be made with respect to the above described embodiments without departing from the spirit and scope of the invention, and that such modifications, alterations, and combinations are to be viewed as being within the ambit of the inventive concept.

I claim:

1. An anchoring apparatus suitable for use in anchoring a first member to a second member, comprising:
a base member configured and arranged to move selectively along an anchor limb; and
a plurality of fingers attached to the base member and being selectively movable, only once, from a non-deployed state to a deployed state.

2. The anchoring apparatus of claim 1, wherein the base member and plurality of fingers are an integral body.

3. The anchoring apparatus of claim 2, wherein the integral body is substantially cylindrical in shape when the plurality of fingers are in the non-deployed state, the integral body having an axially located aperture formed therethough to accommodate the anchor limb.

4. The anchoring apparatus of claim 3, wherein the plurality of fingers each have a first end coupled to the base member and a second free end, the plurality of fingers being separated from one another by a slot

5. The anchoring apparatus of claim 4, wherein the integral body is substantially frusto-conical in shape with the plurality of fingers in the deployed state.

6. The anchoring apparatus of claim 5, wherein the first end of the plurality of fingers are coupled to the base member at a hinge, the hinge being configured and arranged to facilitate movement of the plurality of fingers from the non-deployed state to the deployed state.

7. The anchoring apparatus of claim 6, wherein the hinge comprises an annular ring formed in the integral body.

8. The anchoring apparatus of claim 7, wherein the slot includes a curved inner portion in communication with the annular ring formed in the integral body, the curved inner portion being configured and arranged to relieve stress on the plurality of fingers during movement of the plurality of fingers from the non-deployed state to the deployed state.

9. The anchoring apparatus of claim 1, further comprising:
a wedge member configured and arranged for wedging between the plurality of fingers to thereby selectively move the fingers from the non-deployed state to the deployed state.

10. The anchoring apparatus of claim 9, wherein the wedge member is non-integral with the integral body.

11. The anchoring apparatus of claim 1, wherein the anchoring apparatus is formed of a material selected from the group comprising metals, plastics, polymers, super polymers, engineered plastics, composite materials, and combinations thereof.

12. The anchoring apparatus of claim 1, wherein the first member is an exterior wall of a building and the second member is a façade element.

13. A method of anchoring a first member to a second member, comprising:
attaching an anchor limb to the first member;
providing an anchoring apparatus comprising:
a base member configured and arranged to move selectively along the anchor limb;
a plurality of fingers attached to the base member and being selectively movable, only once, from a non-deployed state to a deployed state;
placing the anchoring apparatus at a predetermined position with respect to the anchor limb; and
wedging a wedge member between the plurality of fingers to thereby selectively move the fingers from a non-deployed state to a deployed state.

14. The method of claim 13, further comprising:
positioning the anchoring apparatus such that, when in a deployed state, at least some of the fingers contact the second member.

15. The method of claim 13, further comprising:
engaging a cap with the anchor limb to thereby captivate the second member between the cap and the plurality of fingers of the anchoring apparatus.

16. The method of claim 13, wherein the anchor limb is a threaded shaft and the base member has an internally-threaded, axially located aperture formed therethough to accommodate the threaded shaft.

17. The method of claim 13, further comprising:
stopping the movement of the base member along the anchor limb at a predetermined location with a stop member associated with the anchor limb.

18. The method of claim 13, wherein the base member and plurality of fingers are an integral body and the wedge member has a substantially frusto-conical shape, and wherein wedging the wedge member between the plurality of fingers to thereby selectively move the fingers from a non-deployed state to a deployed state comprises changing the shape of the integral body from a substantially cylindrical shape with the plurality of fingers in the non-deployed state to a substantially frusto-conical shape with the plurality of fingers in the deployed state.

19. The method of claim 18, wherein wedging the wedge member comprises rotating the wedge member about the anchor limb.

20. The method of claim 13, wherein the first member is an exterior wall of a building and the second member is a façade element.
